(19) United States
(12) Patent Application Publication
(10) Pub. No.: US 2010/0173656 A1
(43) Pub. Date: Jul. 8, 2010

(54) Process for Setting Attributes in a System

(76) Inventor: Peter Albertsson, Norrtalje (SE)

Correspondence Address: NIXON & VANDERHYE, PC, 901 NORTH GLEBE ROAD, 11TH FLOOR, ARLINGTON, VA, 22203, US

(21) Appl. No.: 12/668,790

(22) PCT Filed: Jun. 26, 2008
(86) PCT No.: PCT/SE08/50779

§ 371 Date: Jan. 12, 2010

(30) Foreign Application Priority Data
Jul. 13, 2007 (SE) 0701704-9

(51) Int. Cl. H04W 4/14

(52) U.S. Cl. 455/466

(57) ABSTRACT

A method for setting with a wireless device an attribute in a control system with the aid of an SMS message, which wireless device is arranged to communicate with the control system through a wireless network. According to the invention, the following steps are carried out: that a user causes an application in the wireless device to display a number of different attributes that are specific for the control unit in a graphical view on a display screen of the wireless device, that the user selects one of the attributes, that the application constructs the said SMS message in the form of a text string that comprises the attribute selected, that the application sends the SMS-message through an SMSC server in the wireless network to a telephone number that has been programmed into the application, which telephone number is that of an SMS server, which SMS server either is independent of but in communication with the control system, or is an integrated part of the control system, that the control system receives the SMS message and changes the attribute according to the text string, that the attribute is an availability attribute in a private telephone network, and that the control system communicates with and controls a private branch exchange, which exchange controls the telephone traffic between a plurality of users in the private telephone network.

The present invention relates to a method for setting with a wireless device an attribute in a control system with the aid of an SMS message, which wireless device is arranged to communicate with the control system through a wireless network.

US 2002/0132638 A1 describes a system that allows a user of a mobile telephone to communicate with and control functions in a private telephone network that is controlled through a private branch exchange (PBX). The user controls the private telephone network by controlling a mobile branch exchange (MBX) through SMS messages. The MBX unit in turn controls the PBX unit. The SMS messages are sent through an SMS gateway, which translates the SMS messages into http messages. These are, in turn, sent over the Internet and through a router to the MBX unit.

The disadvantage of this system is that it is relatively complex and vulnerable. If the router is not functioning, for example, the mobile telephone cannot communicate with the MBX unit, and the mobile telephone in this case cannot be used to set, for example, availability attributes in the private telephone network. Instructions sent from the mobile telephone can, in the worst case, be completely lost.

The object of the present invention is to offer an alternative, simpler and safer method of setting user attributes in a system, and in particular, setting availability attributes in a private telephone network.

The method according to the invention is characterised by the steps:
that a user causes an application in the wireless device to display a plurality of different, pre-determined attributes that are specific for the control unit in a graphical view on a display screen of the wireless device,
that the user selects one of the attributes,
that the application constructs the said SMS message in the form of a text string that comprises the attribute selected,
that the application sends the SMS message through an SMSC server in the wireless network, from the wireless device to a telephone number that has been programmed into the application, which telephone number is that of an SMS server, which SMS server either is independent of but in communication with the control system, or is an integrated part of the control system,
that the control system receives the SMS message and changes the attribute according to the text string, and
that the attribute is an availability attribute in a private telephone network, and that the control system communicates with and controls a private branch exchange, which exchange controls the telephone traffic between a plurality of users or subscribers in the private telephone network.

The invention will be described in more detail below with reference to the attached drawings, where

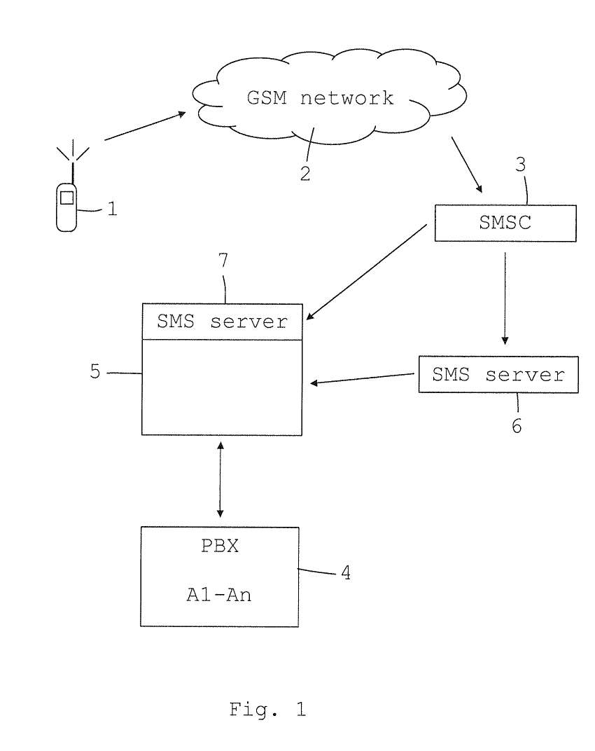

FIG. 1 shows a system for executing the method according to the invention, and

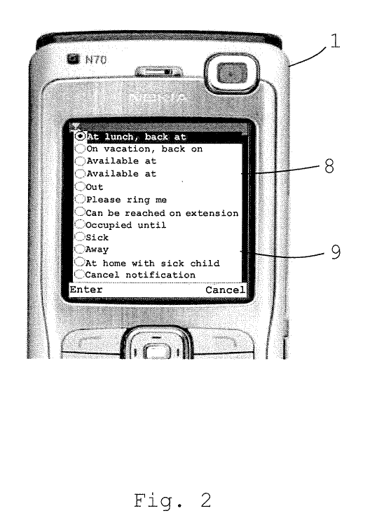

FIG. 2 shows a mobile telephone that is running an application according to the invention.

The system comprises a wireless device 1 in the form of a mobile telephone. The mobile telephone 1 is arranged to communicate with the aid of a wireless network 2 in the form of a mobile telephone network that uses GSM (Global System for Mobile Communications). The GSM network 2 comprises a server 3 that functions as an SMSC (Short Message Service Center). The SMSC server 3 is operated by the operator of the GSM network 2 in order to receive and forward messages of SMS (Short Message Service) type that are sent by a mobile telephone in the GSM network to a second mobile telephone or to an SMS server. The SMSC server uses the SMPP (Short Message Peer-to-Peer) protocol in order to forward the SMS message. One property of the SMSC server is that of being able to store an SMS message until the receiving device is ready to receive the SMS message.

The system comprises also a private branch exchange (PBX) 4. Such an exchange is used to control the telephone traffic between a plurality of users or subscribers A1-An in a private telephone network and between the private telephone network and the public telephone network. The private telephone network may, for example, be the internal telephone network of a company or authority. The exchange 4 may be a hardware exchange or a software exchange.

The system comprises also a computer-based control system 5, which is arranged to communicate with the exchange 2 and to control this exchange. The control system 5 comprises one or a plurality of computers or servers, which in turn comprise applications in the form of computer programs that monitor and control the exchange 2. Such control systems 5 are known per se, and different manufacturers of telephone exchanges have developed their own systems. Certain exchanges manufactured by LG, for example, can be monitored and controlled by a control system that is marketed under the name “LICENSIA CT-SERVER”, and certain telephone exchanges manufactured by SIEMENS can be monitored and controlled by a control system that is marketed under the name “TOTALVIEW”.

The control system 5 has been configured such that it can receive SMS messages from an SMS server. The SMS server may be an external SMS server 6, which is independent of but in communication with the control system 5. The SMS server may, alternatively, be an internal SMS server 7, which is included as an integrated part of the control system 5.

A control system can carry out a number of different functions, but only the function of the control system in association with notification will be described in more detail within the framework of this embodiment. The term “notification” is here used to denote the process by which the control system informs a calling party of the availability status of the called party in the case in which the called party does not answer. Such availability status may be, for example, that the called party is sick or otherwise occupied until a certain time.

The method according to the invention will be described in more detail below, wherein the user of the mobile telephone 1 sets his or her availability status in the control system 5.

The mobile telephone 1 comprises an application in which the user can select in an graphical view 8 (see FIG. 2) on a display screen 9 of the mobile telephone 1 one of a plurality of different pre-determined availability attributes. It is preferable that the application is written in the programming language J2ME (Java 2 Micro Edition), but other programming languages may be used. The availability attributes that are displayed on the display screen 9 are specific for the control system 5, and thus the application has been designed specifically such that it displays only such availability attributes as are offered by the control system 5. The application couples to each availability attribute the specific code that the control system 5 associates with that particular availability attribute.

The selection of certain availability attributes, for example “At lunch, back at”, causes the application to display a new view (not shown in the drawings), in which the user is requested to enter the time at which he or she expects to become available again.

After the user has selected an availability attribute, for example “At lunch, back at”, and in certain cases also a time at which the user expects to become available again, for example 1 pm, and after the user has confirmed this selection, the application automatically forms a text string that can be interpreted by the control system 5 and that comprises the information that the control system 5 is to change the availability attribute of the user as specified by the selection made by the user. With reference to the example described above, such a text string may, for example, be “01 220 1300”, where “01” if the specific code used by the control system 5 to denote “At lunch, back at”, “220” is the number of the extension of the user in the private telephone network, and “1300” is a four-digit number that represents the time at which the user will once again become available. It should be noted that the structure of the text string, except for the codes for the availability attributes, is specific for the control system 5. The structure of the text string in this case is: availability code, space, extension number, space, and, in certain cases, four digits that represent the time at which it is expected that the user once again will become available. The structure of the text string may be different for other control systems, for example control systems from another manufacturer. It is preferable that the application retrieved the extension number of the mobile telephone 1 in the private telephone network from a database in the mobile telephone 1, in which database this number has previously been stored.

When the application has formed the text string, the application sends the text string as an SMS message, through the operator-specific SMSC server 3, to the SMS server that is associated with the control system 5, which SMS server may be the external SMS server 6 or the internal SMS server 7. It is preferable that the application retrieved the telephone number of the SMS server from the above-mentioned database in the mobile telephone 1, in which database this telephone number has previously been stored. The SMCS server uses the SMPP (Short Message Peer-to-Peer) protocol in order to forward the SMS message to the SMS server, and communication between the mobile telephone 1 and the control system 5 is of ONE-WAY SMS type. Since the SMSC server can store the SMS message until the SMS server 6 or 7 is ready to receive it, there is no risk that the SMS message that has been sent be lost: it will always be received by the SMS server.

When the control system 5 has received the text string, the control unit 5 interprets the information in the text string and uses this information to reset the availability attribute of the user in the control unit 5. The control unit 5 can subsequently communicate with the exchange 4 in order to make the changed availability attribute available in the private telephone network.

Thus, the application in the mobile telephone 1 uses codes that are specific to the control system when the text strings are formed, while the telephone number of the SMS server and the extension number of the mobile telephone have been programmed into the application. Thus the application is adapted to the particular control system 5 that controls the private telephone network to which the mobile telephone 1 belongs.

The invention has been described above based on a particular embodiment. It will be understood, however, that other embodiments and variants are possible within the scope of the invention. The wireless device may be, for example, a hand-held computer, a personal digital assistant (PDA) or another type of portable device that is capable of wireless communication through WMA (Wireless Messaging Application Program Interface) technology, instead of a mobile telephone, whereby the requirement on the control unit is that it also must be able to communicate directly or indirectly with the wireless device through WMA technology. The invention can be used to set other attributes or parameters in a control system for a exchange, instead of availability attributes. The invention can be used also in other fields of technology than telecommunication, such as, for example, to reset time clocks, in which an attendance attribute is used instead of an availability attribute, or within the health care system in order to reset health attributes for patients.

1. A method for setting with a wireless device an attribute in a control system with the aid of an SMS message, which wireless device is arranged to communicate with the control system through a wireless network, characterised by the steps:
that a user causes an application in the wireless device to display a plurality of different, pre-determined attributes that are specific for the control unit in a graphical view on a display screen of the wireless device,
that the user selects one of the attributes,
that the application constructs the said SMS message in the form of a text string that comprises the attribute selected,
that the application sends the SMS-message through an SMSC server in the wireless network, from the wireless device to a telephone number that has been programmed into the application, which telephone number is that of an SMS server, which SMS server either is independent of but in communication with the control system, or is an integrated part of the control system,
that the control system receives the SMS message and changes the attribute according to the text string, and
that the attribute is an availability attribute in a private telephone network, and that the control system communicates with and controls a private branch exchange, which exchange controls the telephone traffic between a plurality of users or subscribers (A1-An) in the private telephone network.

2. The method according to claim 1, characterised in that the above-mentioned step in which the application forms the said SMS message in the form of a text string also comprises the inclusion in the text string of an extension number in the private telephone network that has been programmed into the application and that is specific for the user.

3. The method according to claim 2, characterised in that the application retrieves the telephone number of the SMS server and the extension number of the user from a database in the application.

4. The method according to any one of claim 1, characterised in that the wireless device is a mobile telephone.
